(19) United States
(12) Patent Application Publication
(10) Pub. No.: US 2010/0267379 A1
(43) Pub. Date: Oct. 21, 2010

(54) TRANSMISSION OF VEHICLE INFORMATION

(75) Inventors: Ulrich Stählin, Eschborn (DE); Marc Menzel, Marburg (DE)

Correspondence Address: RATNERPRESTIA, P.O. BOX 980, VALLEY FORGE, PA, 19482, US

(73) Assignee: Continental Teves AG&Co. oHG, Frankfurt (DE)

(21) Appl. No.: 12/743,064

(22) PCT Filed: Jul. 14, 2008
(86) PCT No.: PCT/EP2008/059190

§ 371 Date: May 14, 2010

(30) Foreign Application Priority Data
Nov. 15, 2007 (DE) 10 2007 054 896.8
Mar. 20, 2008 (DE) 10 2008 015 232.2

(51) Int. Cl. H04W 4/00

(52) U.S. Cl. 455/426.1

(57) ABSTRACT

A communication device, system and method relating to vehicle information being transmitted to other vehicles by virtue of a vehicle using a cellular network to send to a server which then transmits said information via the network to particular, selected vehicles which have a continual communication link to the server. The intervals of time for such transmissions match the dynamics of the relevant events, so that the data traffic can be minimized.

### CROSS REFERENCE TO RELATED APPLICATIONS

This application is the U.S. national phase application of PCT International Application No. PCT/EP2008/059190, filed Jul. 14, 2008, which claims priority to German Patent Application No. DE 10 2007 054 896.8, filed Nov. 15, 2007, and German Patent Application No. 10 2008 015 232.2, filed Mar. 20, 2008, the contents of such applications being incorporated herein by reference.

### FIELD OF THE INVENTION

The invention relates to communication and safety engineering for vehicles. In particular, the invention relates to a communication device for a vehicle for communication with a control center, a communication system, a vehicle, the use of a communication device in a vehicle, a method for communication between a vehicle and a control center, a computer program product and a computer-readable medium.

### BACKGROUND OF THE INVENTION

Vehicle-to-vehicle communication and vehicle-to-infrastructure communication, subsequently also called vehicle-to-X (C2X) communication, are typically linked to WLAN-based communication engineering. This communication engineering has a typical chicken-and-egg problem: it is only worth integrating the communication in a vehicle if a correspondingly large number of other vehicles are equipped therewith, since otherwise extensive use does not work correctly.

Techniques for C2X based on cellular radio are already known. These techniques can be combined with the techniques described in this invention. Floating car data is likewise already known.

### SUMMARY OF THE INVENTION

It is an object of the invention to provide improved transmission of vehicle information.

The invention specifies a communication device, a communication system, a vehicle, a use, a method, a computer program product and a computer-readable medium in accordance with the features described herein. Developments of the invention are also described herein.

The exemplary embodiments described relate in equal measure to the communication device, the communication system, the vehicle, the use, the method, the computer program product and the computer readable medium.

In line with one exemplary embodiment of the invention, a communication device for a vehicle for communication with a control center is specified, wherein the communication device has a position-finding unit for determining a position of the vehicle, a control unit for producing first information data and a communication unit for setting up and holding a communication link to the control center and for sending the first information data to the control center using the communication link.

The communication link is based on a cellular communication network, and the first information data contain data about the position of the vehicle.

The use of existing mobile communication techniques, as are used in 2G, 3G, 3.5G and 4G mobile radio networks, allows information about vehicles to be transmitted from the relevant vehicles to a control center, which information would otherwise not be available until widespread introduction of WLAN-based C2X communication. Other cellular communication techniques which can be used by way of example are WLAN via Hot Spots, WiMax, etc.

The inventive transmission of the vehicle information advantageously requires very small volumes of data and advantageously protects the privacy of the vehicle drivers and vehicle occupants by transmitting positions in a manner which can be scaled over time.

In this way, a vehicle-related piece of information can be transmitted easily and safely to vehicles which are in the surroundings.

By way of example, the vehicle is a motor vehicle, such as a car, bus or heavy goods vehicle, or else is a rail vehicle, a ship, an aircraft, such as a helicopter or airplane, or is a bicycle, for example.

At this juncture, it should be pointed out that, within the context of the present invention, GPS is representative of all global navigation satellite systems (GNSS), such as GPS, Galileo, GLONASS (Russia), Compass (China), IRNSS (India), . . . .

In line with a further exemplary embodiment of the invention, the communication link is an Internet Protocol based (IP) link.

In line with a further exemplary embodiment of the invention, the communication link is maintained over the entire travel time of the vehicle. This allows the control center to transmit relevant data to the individual vehicles at any time.

In line with a further exemplary embodiment of the invention, the communication device also has a detection unit for capturing measured values or for detecting events, wherein the control unit is designed to produce second information data on the basis of the captured measured values or the detected events, which are likewise transmitted to the control center.

The communication device is thus not merely designed to transmit a vehicle position to the control center, but rather also to transmit other relevant data which are detected by the vehicle sensor system. If appropriate, the measurement data can be analyzed, evaluated and/or media-converted prior to the transmission.

The term media conversion quite generally denotes the translation, transformation or conversion of a file from one file format to another. This applies to the transfer of data between different media and file systems as well as to the transmission of data from one storage medium to another. By way of example, all information data can be transformed into voice or video information prior to the transmission.

In line with a further exemplary embodiment of the invention, the captured measured values or the detected events correspond to the operation of hazard lights of the vehicle, a slippery road (for example on account of ice or soiling) or a piece of traffic information, such as signage.

In line with a further exemplary embodiment of the invention, the first information data are transmitted at first intervals of time. In addition, the second information data are transmitted at second intervals of time, wherein the second intervals of time are shorter than the first intervals of time.

In other words, the second information is transmitted at a higher repetition rate than the first information.

The repetition rate at which said information is transmitted matches the dynamics of the vehicle motion or the dynamics of the detected events or a rate of change of the captured measured values, for example.

In line with a further exemplary embodiment of the invention, the communication device also has a unit for calculating a route of the vehicle, wherein the second information data contain data about the calculated route of the vehicle.

By way of example, such a unit is a navigation unit in the vehicle.

In line with a further exemplary embodiment of the invention, the communication link is based on UMTS, GPRS, LTE, WLAN (via Hot Spots) or WiMax.

In line with a further exemplary embodiment of the invention, the communication device is designed to provide data integrity for the dynamic change of an identifier (ID) for the communication device.

By way of example, said ID change may relate to what is known as the MAC ID (that is to say the physical hardware address of the communication unit), the IP ID or the vehicle-to-vehicle ID.

By way of example, the dynamic change of the identifier is made at random intervals of time within the vehicle, that is to say is not triggered externally.

This allows the data integrity to be increased.

In line with a further exemplary embodiment of the invention, the communication device is in the form of what is known as an eCall unit (eCall module).

In line with a further exemplary embodiment of the invention, a communication system for communication between a vehicle and a control center is specified which has a communication device as described above and a control center for receiving information data and for transmitting data corresponding to said information data to selected further vehicles.

By way of example, the control center comprises a server which sends all the relevant data to those vehicles for which said information is intended. In this context, the vehicles are associated on the basis of the transmitted vehicle positions and the relevant vehicle identifier (vehicle ID).

In line with a further exemplary embodiment of the invention, the transmission rate at which the corresponding data are transmitted matches dynamics of the captured measured values or of the detected event. This matching can be performed by the control center or can be prescribed or triggered by the sending vehicle.

In line with a further exemplary embodiment of the invention, the communication system is designed to ascertain a probable whereabouts of the vehicle.

By way of example, before the start of a journey, the driver transmits a planned route to the control center, together with a starting position and a starting time. From this time, the control center can calculate at what time the vehicle is approximately at what point on the route. Only if the vehicle leaves the calculated route are new position data sent to the control center. The route planning can be performed internally in the vehicle or, by way of example, also online at home.

This allows the data traffic to be reduced.

In line with a further exemplary embodiment of the invention, the use of a communication device as described above in a vehicle is specified.

In line with a further exemplary embodiment of the invention, a method for communication between a vehicle and a control center is specified in which a position of the vehicle is determined and first information data are produced. The first information data contain data about the position of the vehicle. In addition, a communication link to the control center is set up and held, followed by the first information data being sent to the control center using the communication link. The control center receives the information data and transmits data corresponding to the information data to further vehicles which are in the surroundings of the vehicle. The communication link is based on a cellular communication network, for example a mobile radio network.

At this juncture, it should be pointed out that the position finding for the vehicle can also be performed by means of cell positioning. This is appropriate particularly when using GSM, UMTS or LTE networks, but it is also possible for WiMax or WLAN (via Hot Spots).

In line with a further exemplary embodiment of the invention, a computer program product is specified which, when executed on a processor, instructs the processor to perform the following steps: determination of a position of the vehicle, production of first information data, setup and holding of a communication link to the control center, sending of the first information data to the control center using the communication link, wherein the first information data contain data about the position of the vehicle; and wherein the communication link is based on a cellular communication network.

In line with a further exemplary embodiment of the invention, a computer-readable medium is specified which stores a computer program product which, when executed on a processor, instructs the processor to perform the steps specified above.

In line with a further exemplary embodiment of the invention, a vehicle having a communication device as described above is specified.

### BRIEF DESCRIPTION OF THE DRAWINGS

Preferred exemplary embodiments of the invention are described below with reference to the figures.

FIG. 1 shows a schematic illustration of a communication device based on an exemplary embodiment of the invention.

FIG. 2 shows a schematic illustration of a communication system based on an exemplary embodiment of the invention.

FIG. 3 shows a flow chart for a method based on an exemplary embodiment of the invention.

The illustrations in the figures are schematic and not to scale.

### DETAILED DESCRIPTION OF THE INVENTION

In the description of the figures which follows, the same reference numerals are used for the same or similar elements.

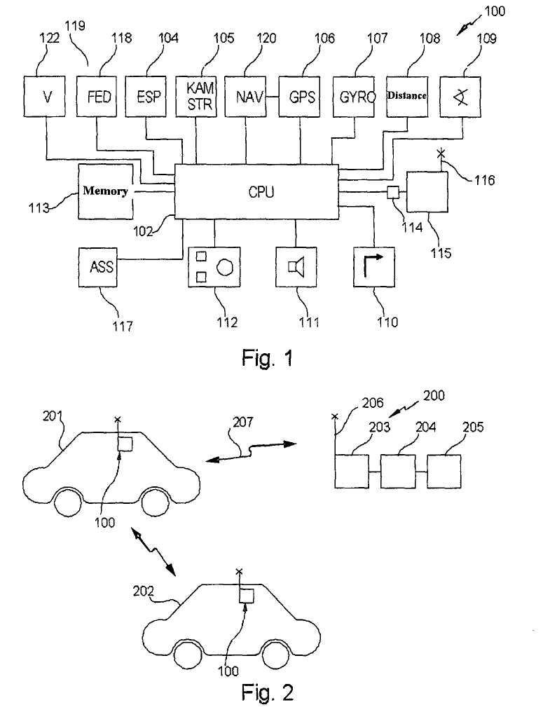

FIG. 1 shows a schematic illustration of components of a communication device for a vehicle for communication with a control center. By way of example, the communication device 100 is installed in the vehicle and has a communication unit 115 with an antenna 116, has a detection unit 119 with a position-finding unit 106 and has a control unit 102.

Data to be sent which are transmitted by the control unit 102, which is in the form of a CPU, for example, to the communication unit 115 can be encrypted by means of an encryption device 114. Similarly, the received data transmitted from the communication unit 115 to the control unit 102 can be decrypted by the encryption unit 114.

In addition, a dynamic ID change can be performed.

This allows the risk of misuse to be reduced.

The control unit 102 has an input unit 112 connected to it. The input unit 112 allows various settings to be made for the communication device and possibly also for a navigation unit 120 linked thereto. In addition, a visual output unit in the form of a monitor 110 is provided which can be used to output routing information or warning information, for example. This information can also be output by means of the audible output unit 111. Output by means of the audible output unit 111 has the advantage that the driver is less distracted from what is currently happening in the traffic.

A memory element 113 which is connected to the control unit 102 or is integrated in the control unit 102 stores digital map data (e.g. in the form of navigation map data) in the form of data records. By way of example, the memory element 112 also stores additional information about traffic restrictions, infrastructure devices and the like in association with the data records.

The term “digital maps” can also be understood to mean maps for advanced driver assistance systems (ADAS), without any navigation taking place.

In addition, a driver assistance system 117 is provided which is supplied with the digital map data or warnings or other information from the communication.

For the purpose of determining the current vehicle position, the communication device has a navigation unit 120 which is connected to the satellite navigation receiver 106. The satellite navigation receiver 106 is used to receive navigation signals from Galileo satellites or GPS satellites, for example. Naturally, the navigation unit with the satellite navigation receiver 106 may also be designed for other satellite navigation systems.

Since the navigation signals cannot always be received in city centers, for example, the communication device also has a direction sensor 107, a distance sensor 108, a steering wheel angle sensor 109, a spring excursion sensor 118, an ESP sensor system 104 and possibly an optical detector 105, for example in the form of a camera or beam sensor (radar or lidar sensor), for the purpose of performing compound navigation. In addition, the detection unit 119 has a speedometer 122.

The signals from the GPS receiver and from the other sensors are handled in the control unit 102 or else in the navigation unit 120. The vehicle position ascertained from said signals is aligned with the roadmaps using a map matching. The routing information obtained in this manner is finally output via the monitor 110.

Besides the use of a satellite navigation system, the vehicle position can also follow from other vehicle sensor systems or from cell positioning in connection with a radio network.

FIG. 2 shows a schematic illustration of a communication system based on an exemplary embodiment of the invention. Two vehicles 201, 202 are provided which each have a communication device 100. In addition, a control center 200 with a communication unit 203, an antenna 206, a server 204 and a data memory 205 is provided. The control center and the communication devices 100 in the vehicles 201, 202 can communicate with one another via the radio transmission link 207.

The communication is effected using cellular communication techniques, such as GPRS, UMTS, LTE, WiMax, WLAN (via Hot Spots), . . . . Said communication techniques are already used for a mobile radio, which means that the necessary infrastructure therefor is in place. A problem with cellular radio is the latency. This means that it is sometimes not possible to represent all the C2X methods for vehicle safety, but it is already possible to depict a large number. An exemplary embodiment of the invention comprises the following method steps:
The participating vehicles set up an IP link to the server or the control center 200. This IP link is maintained during the whole journey.
The vehicles send their current position, which has been ascertained by means of GPS or Galileo, other vehicle sensor systems or cell positioning, for example, to the server at relatively long intervals (e.g. every five minutes). The server can then establish an area in which the vehicle is probably situated.
If a route has been planned (e.g. using the navigation appliance 120), this route is likewise sent to the sever. In the event of deviations from this route or replanning on account of a tailback, the replanned route is sent to the server again.
If a vehicle experiences an event which needs to be transmitted to other vehicles, this event, including the position of the event and any other necessary information, is sent to the server at short intervals (e.g. every five seconds). The server then distributes the information about the event to all the vehicles which are in proximity to the vehicle. This involves matching the transmission rate from the server to the vehicle to the dynamics of the event. If the event is stationary (for example if it is a broken down vehicle), for example, transmission occurs rarely. If the event is moving very erratically, transmission occurs more frequently. Possible events are:
   Hazard lights (possibly with further classification of the initiating event);
   Emergency vehicle in action;
   Road slipperiness or coefficient of friction, e.g. ascertained by means of ABS/ESP/TCS or vehicle safety systems;
   The speed of the vehicle is significantly below the speed limit for the current road section, such as in the case of a tailback hazard;
   Diversion management (on highways and in cities);
   Travel time information system;
   Road sign assistant;
   Road works information system;
   Road works transit assistant;
   Preferential traffic light change for emergency vehicles;
   Local information services; and
   Further C2X applications with low demand on the latency of the data transmission.
   Additionally, traffic information, information about road works, information about parking space, information about gas prices nearby, etc. is also transmitted to the vehicle, if desired.

The same hardware can also be used to provide a traffic light phase assistant. Advantageously, all of these options are implemented by means of a piece of eCall hardware, since this already requires cellular communication and positioning (e.g. by a GPS).

The advantage of the method described is the use of already existing communication techniques for applications of C2X communication which are otherwise reliant on 802.11p, which has not yet been definitively standardized. Since information is sent only very sporadically (apart from in the case of an event), data protection is also ensured. For further data protection, techniques such as dynamic ID change are also used. Since information is sent only very rarely, the communication costs can also be regarded as very low.

For better traffic information, the method can be combined with floating car data, although this may endanger data protection. If the number of subscribers using floating car data is large enough and techniques such as dynamic ID change are used, however, it can also be assumed in this case that the method satisfies the data protection conditions.

The text below describes two exemplary embodiments, which can naturally also be combined with one another.

### Exemplary Embodiment 1

The participating vehicles are warned by an approaching emergency vehicle (such as an ambulance, fire brigade, police, . . . ). An indication is given of where the emergency vehicle is approaching the vehicle from.

As soon as an emergency vehicle sets off on an assignment (and has switched on its blue light and/or siren), it reports its position, including a time stamp, to the service provider by GPRS. By way of example, an IP link is used for this. For positioning and for the time stamp, GPS is advantageously used. If the route of the emergency vehicle is already known, this is likewise reported to a service provider. The position is updated at constant intervals, e.g. at intervals of five seconds.

The vehicles likewise report their position, including a time stamp, to a service provider, for example likewise via an IP link. If it is already known what route is being used (e.g. as a result of the planning in a navigation appliance), this is likewise transmitted to the service provider. Normally, the vehicle's own position is transmitted only if the road being used changes or if the vehicle departs from the planned route. Otherwise, the position is reported again only at very long intervals of time, for example at intervals of five minutes.

If an emergency vehicle is now in proximity to the vehicle's own position, the service provider sends this information to the driver's own vehicle, together with the road segment on which the emergency vehicle is situated and together with the planned route of the emergency vehicle. If the interval between the road segment of the emergency vehicle and the road segment of the driver's own vehicle is short (that is to say it is below a predetermined threshold value) or if both are situated in the same road segment, the driver's own vehicle sends a short report to the service provider. From this time onward (subsequently called report time or report threshold), the driver's own vehicle receives a transmission indicating the current position of the emergency vehicle at short intervals. If the emergency vehicle has passed the driver's own vehicle, the driver's own vehicle sends a report to the service provider again and hence terminates the transmission of the position of the emergency vehicle at short intervals. Now only the road segment, etc., is sent, as described right at the outset.

If there is an assumed latency of two to three seconds for the transmission of the data by means of GPRS, it is in each case necessary to know the road segment in which the vehicle and the emergency vehicle are situated. If both are situated within the report threshold, the position of the emergency vehicle in this road segment is additionally of interest.

### Exemplary Embodiment 2

Vehicles are informed about the fact that another vehicle has switched on its hazard lights. It is indicated how far away this hazard is and possibly what the reason for the warning is. Possible reasons may be a flat tire on a vehicle or leaking gas.

### 1. The Warning Vehicle:

As soon as the warning function is activated, GPRS/UMTS/ . . . is used to send a report to a server. The report is repeated every 20 seconds for as long as the warning function remains activated. The report comprises a time stamp, a GPS position with an accuracy, matched map data (for example road name, geographical position, . . . ) if available, and possibly route data from the navigation appliance. In addition, it is also possible to send information which allow more accurate determination of why the hazard lights have been activated (e.g. “burst tire”).

### 2. The Warned Vehicle:

The vehicle “subscribes to” the warning service by sending its position to the sever by GPRS/UMTS/ . . . every five minutes. It updates its position more quickly if it is moved more than 500 meters in a town or 10 kilometers on a motorway since its last position report or if it leaves its planned route. This route is immediately sent to the server.

### 3. The Server

As soon as a warning report is reported, the server compares its position with the positions of the subscribers and immediately forwards said message via GPRS/UMTS/ . . . to all the subscribers (situated within a radius of one kilometer for example). As soon as this has been executed, all subscribers within the radius of five kilometers are warned. In this case, the warning is repeated every 20 seconds until the warning vehicle terminates the warning report.

### 4. The Warned Vehicle:

The vehicle has received the data and compares the data with its own route/map/GPS data and if necessary generates a warning to the driver or allows the navigation appliance to calculate an alternative route.

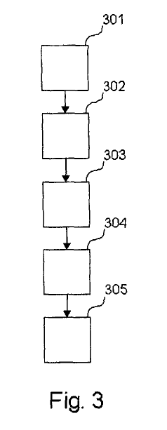

FIG. 3 shows a flowchart for a method based on an exemplary embodiment of the invention. In step 301, an IP link to a server (or to a control center) is set up and is held over the entire travel time. In step 302, the driver's own vehicle position is determined and is sent to the server at relatively long intervals of time. In addition, in step 303, a planned route is sent to the server. In step 304, certain events, including the corresponding position and possibly supplementary information, are sent to the server at short intervals. Then, in step 305, the server (possibly after appropriate processing/analysis of the received information) sends the relevant events to certain, selected vehicles in the surroundings of the events.

The vehicles can use the communication link to transmit their current position cyclically to the server, whereupon the server determines a geographical area in which the vehicle is probably situated. Following the occurrence of an event which is relevant to the vehicle, information representing said event and also the position of the event which is relevant to the vehicle and metainformation about the event which is relevant to the vehicle are transmitted to the server at shorter intervals of time, and the server then forwards said information to other vehicles. The transmission rate from the server to the vehicles matches the dynamics of the events.

In addition, it should be pointed out that “comprising” and “having” do not exclude other elements or steps, and “a” or “an” does not exclude a large number. Furthermore, it should be pointed out that features or steps which have been described with reference to one of the above exemplary embodiments can also be used in combination with other features or steps from other exemplary embodiments described above. Reference symbols in the claims should not be regarded as restrictions.

1.-18. (canceled)

19. A communication device for a vehicle for communication with a control center, said communication device comprising:
a position-finding unit for determining a position of the vehicle;
a control unit for producing first information data;
a communication unit for setting up and holding a communication link to the control center and for sending the first information data to the control center using the communication link;
wherein the communication link is based on a cellular communication network; and
wherein the first information data contain data about the position of the vehicle.

20. The communication device as claimed in claim 19, wherein the communication link is an IP link.

21. The communication device as claimed in claim 19, wherein the communication link is maintained over the entire travel time of the vehicle.

22. The communication device as claimed in claim 19, further comprising:
a detection unit for capturing measured values or for detecting events;
wherein the control unit is configured to produce second information data on the basis of the captured measured values or the detected events, which are likewise transmitted to the control center.

23. The communication device as claimed in claim 22, wherein the captured measured values or the detected events correspond to the operation of hazard lights, a slippery road or a piece of traffic information.

24. The communication device as claimed in claim 22, wherein the first information data are transmitted at first intervals of time; wherein the second information data are transmitted at second intervals of time; and wherein the second intervals of time are shorter than the first intervals of time.

25. The communication device as claimed in claim 22, further comprising:
a unit for calculating a route for the vehicle;
wherein the second information data contain data about the calculated route of the vehicle.

26. The communication device as claimed in claim 19, wherein the communication link is based on UMTS, GPRS, LTE, WiMax or WLAN, in this case via Hot Spots.

27. The communication device as claimed in one claim 19, wherein the communication device is configured to provide data integrity for the dynamic change of an identifier for the communication device.

28. The communication device as claimed in claim 19, configured as an eCall unit.

29. A communication system for communication between a vehicle and a control center, said communication system comprising:
a communication device as claimed in claim 19; and
a control center for receiving the information data and for transmitting data corresponding to the information data to selected further vehicles.

30. The communication system as claimed in claim 29, wherein the transmission rate at which the corresponding data are transmitted matches dynamics of the captured measured values or of the detected event.

31. The communication system as claimed in claim 29, wherein the communication system is configured to ascertain a probable whereabouts of the vehicle.

32. The use of a communication device as claimed in claim 19 in a vehicle.

33. A method for communication between a vehicle and a control center, said method comprising:
determining a position of the vehicle;
producing first information data;
setting up and holding a communication link to the control center;
sending the first information data to the control center using the communication link;
receiving the information data in the control center;
transmitting data corresponding to the information data from the control center to further vehicles which are in the surroundings of the vehicle;
wherein the first information data contain data about the position of the vehicle; and
where the communication link is based on a cellular communication network.

34. A computer program product which, when executed on a processor, prompts the processor to perform the following steps:
determining a position of the vehicle;
producing first information data;
setting up and holding of a communication link to the control center;
sending of the first information data to the control center using the communication link;
wherein the first information data contain data about the position of the vehicle; and
wherein the communication link is based on a cellular communication network.

35. A computer readable medium which stores a computer program product which, when executed on a processor, instructs the processor to perform the following steps:
determining a position of the vehicle;
producing first information data;
setting up and holding of a communication link to the control center;
sending of the first information data to the control center using the communication link;
wherein the first information data contain data about the position of the vehicle; and
wherein the communication link is based on a cellular communication network.

36. A vehicle having a communication device as claimed in claim 19.
